(19) United States
(12) Patent Application Publication
(10) Pub. No.: US 2008/0144134 A1
(43) Pub. Date: Jun. 19, 2008

(54) SUPPLEMENTAL SENSORY INPUT/OUTPUT FOR ACCESSIBILITY

(76) Inventors: Mohamed Nooman Ahmed, Louisville, KY (US); Amanda Kay Bridges, Winchester, NY (US); Stuart Willard Daniel, Lexington, KY (US); William James Gardner Flowers, Lexington, KY (US); Charles Edward Grieshaber, Versailles, KY (US); Dennis Herbert Hasselbring, Lexington, KY (US); Michael Earl Lhamon, Lexington, KY (US); Chad Eugene McQuillen, Lexington, KY (US); Michael Ray Timperman, Versailles, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/555,015

(22) Filed: Oct. 31, 2006

(51) Int. Cl. H04N 1/46

(52) U.S. Cl. 358/500

(57) ABSTRACT

A method for a user to control a peripheral device includes soliciting input from a user through assistive technology, receiving input from the user in response to soliciting, and executing a job generated from the input.

### CROSS REFERENCES TO RELATED APPLICATIONS

This application relates to U.S. non-provisional patent applications titled, “Access to Networked Peripheral Device for Impaired Users” and “Peripheral Device,” both of which were filed contemporaneously herewith.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present invention relates generally to printers and multi-function peripheral (MFP) devices, and more particularly to a peripheral device user interface (UI) adapted to printers and MFP devices for disabled or physically impaired users.

2. Background

Many of today's printers, MFP devices and other information technology (IT) devices support “walk-up” user-initiated functions such as confidential print, copy, facsimile, and so forth. A UI typically enables a selection of a function and related attributes to be entered for the selected function.

In 1998, Congress amended the Rehabilitation Act to require Federal agencies to make their electronic and information technology accessible to people with disabilities. Inaccessible technology interferes with an individual's ability to obtain and use information quickly and easily. Section 508 was enacted to eliminate barriers in information technology, to make available new opportunities for people with disabilities, and to encourage development of technologies that will help achieve these goals. The law applies to all Federal agencies when they develop, procure, maintain, or use electronic and information technology. Under Section 508 (29 U.S.C. § 794d), agencies must give disabled employees and members of the public access to information that is comparable to the access available to others.

### SUMMARY OF THE INVENTION

The present invention provides methods and apparatuses, including computer program products, for a supplemental sensory input/output for accessibility to peripheral devices.

In general, in one aspect, the present invention features a method for controlling a peripheral device including soliciting input from a user through assistive technology, receiving input from the user in response to the soliciting, and executing a job from the input. Such method may also include receiving an activation signal from the user.

In embodiments, the assistive technology can be an interactive voice response (IVR) system, a large viewing screen, a screen reader, or any other device or system which assists a user with a disability.

Soliciting input can include and prompting the user to enter input. Prompting can be verbal.

The activation signal can be an alphanumeric input, an off-hook headset signal or a signal from a connected portable auxiliary device. The auxiliary device can be a Universal Serial Bus (USB) device.

Input can be one or more alphanumeric characters representing one or more desired functions, parameters, instructions or attributes or a delimiter character.

The job can include a request for the peripheral device to perform a function. The job can also include one or more attributes, parameters or instructions associated with such function.

In another aspect, the present invention features a method for controlling a peripheral device equipped with assistive technology including, soliciting input from a user through a wizard, determining whether the received input is valid, receiving a completion indication from the user through a response to the wizard, and executing a job in response to the received completion indication.

In embodiments, the wizard can be a script of interactive audible requests. The interactive audible requests can be synthetic voice prompts.

The input can include one or more alphanumeric characters representing one or more peripheral device functions and associated attributes, parameters or instructions.

Determining can include checking or verifying that the received input represents valid peripheral device functions and associated attributes, instructions or parameters.

The completion indication can be a special function key on the peripheral device. The job can include a request for the peripheral device to perform a function. The job may also include one or more attributes, parameters or instructions associated with the function.

The present invention can be implemented to realize one or more of the following advantages.

Methods enable an impaired user to invoke a process or wizard to guide such user through a job creation and execution process using a combination of audio and/or video feedback enhancements. In particular, methods enable a user to ascertain that a multifunction peripheral device is in a ready state; to initiate a wizard which in turns provides information, guidance, and audio and/or enhanced visual feedback; and to enable selection of a device function and its associated attributes, parameters or instructions, all without a need to see or discern information presented on the device's standard user interface. Information can be presented on a standard user interface while the wizard is executing so that a user with limited visual impairment can discern the information.

One implementation of the present invention provides all of the above advantages.

### BRIEF DESCRIPTION OF THE DRAWINGS

The above-mentioned and other features and advantages of the present invention, and the manner of attaining them, will become more apparent, and the present invention will be better understood by reference to the following description of embodiments of the present invention in conjunction with the accompanying drawings, wherein:

FIG. 1 is a block diagram of an exemplary multifunction peripheral (MFP) device.

FIG. 2 is a block diagram of an exemplary operation panel adapted to the MFP device of FIG. 2.

FIG. 3 is a flow diagram of a process for creating and executing a job in accordance with the present invention.

Like reference numbers and designations in the various drawings indicate like elements.

### DETAILED DESCRIPTION

It is to be understood that the present invention is not limited in its application to the details of construction or the arrangement of components set forth in the following description or illustrated in the drawings. The present invention is capable of other embodiments and of being practiced or of being carried out in various ways. Also, it is to be understood that the phraseology and terminology used herein is for the purpose of description and should not be regarded as limiting. The use herein of “including,” “comprising,” or “having” and variations thereof is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that embodiments of the present invention may include both hardware and electronic components or modules that, for purposes of discussion, may be illustrated and described as if the majority of the components were implemented solely in hardware. However, one of ordinary skill in the art, based on a reading of this detailed description, would recognize that, in at least one embodiment, the electronic based aspects of the present invention may be implemented in software. As such, it should be noted that a plurality of hardware and software-based devices, as well as a plurality of different structural components may be utilized to implement the present invention. Furthermore, and as described in subsequent paragraphs, the specific mechanical configurations illustrated in the drawings are intended to exemplify embodiments of the present invention, and other alternative mechanical configurations are possible.

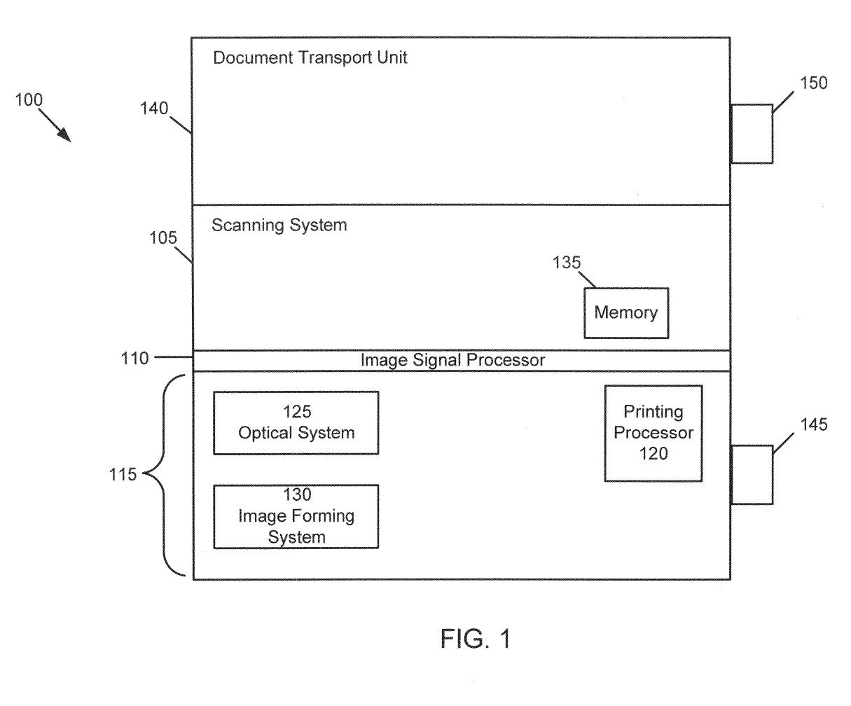

As shown in FIG. 1, an exemplary multi-function peripheral (MFP) device 100 includes a scanner, scanning unit or scanning system 105 and an image signal processor 110. MFP device 100 includes a printer or printing unit 115 having a printing processor 120, an optical system 125, and an image forming system 130. The MFP device 100 also includes a memory 135, a document transport unit 140, a duplex unit 145 and an exemplary operation (e.g., input/output) panel 150. The operation panel 150 is attached, for example, on top of MFP device 100 for executing operations or functions, such as copying, faxing, scanning, or e-mailing and for displaying device options or conditions, such as duplex copying or stapling. In an alternate embodiment, operation panel 150 may be integrated or housed within MFP device 100.

Scanning system 105 reads a document and converts the obtained data into image data. Memory 135 transmits image data and color data, if applicable, to the printing unit 115 either directly, or through a memory installed therein. The image data and color data may also be transmitted to a user's workstation or computer for further processing or storage. The image data and color data may also be transmitted to a desired destination by facsimile or electronic mail.

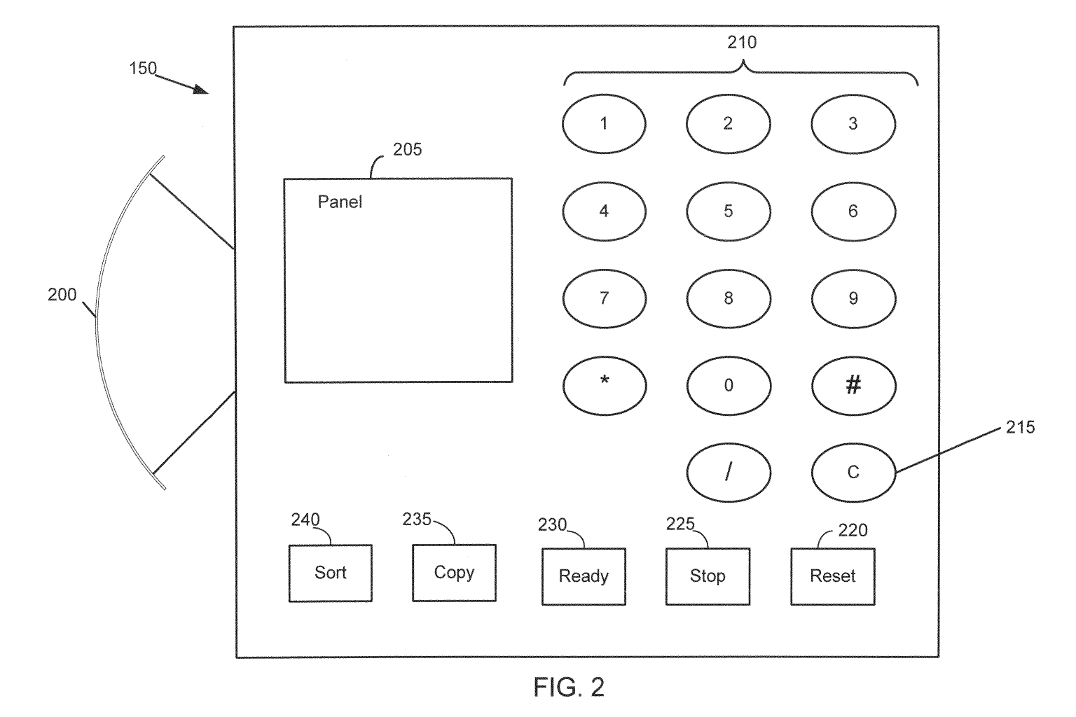

As shown in FIG. 2, operation panel 150 can include, for example, a signaling device 200, such as a sound generating or audio signaling device (e.g., beeper, tone generator, audio speaker, and so forth) and a display screen or touch panel 205 for indicating a warning, such as jamming, a service man call, and paper empty, or other information, attributes or conditions such as a threshold level, magnification ratio, and copy sheet size. A vision-impaired user may not be able to discern visual indications on operation panel 150 while a hearing-impaired user may not be able to discern audio indications from signaling device 200. To aid a particular impaired user or multiple impaired users, operation panel 150 can include assistive technology (not shown). For example, assistive technology can include an IVR system, large viewing screen, screen reader, touch screen, keyboard, mouse, voice recognition system, digital ink pen, track pad, track ball or sound generating device. As such, operation panel 150 enables input discernable by sight (e.g., color, size, graphics), touch (e.g., size, shape, location), and/or sound (e.g., tone generation). The exemplary description below details operation panel 150 for a vision-impaired user. However, as will be appreciated by one of ordinary skill in the art, other systems may be designed or implemented for other types of disabilities.

Operation panel 150 may also include a keypad or key group 210 entering input such as the desired number of copies and magnification ratio; a “Clear” key 215 for clearing the input entered at keypad 210; a panel “Reset” key 220 for clearing all of the set conditions; a “Stop” key 225 for stopping or halting operation of MFP device 100; and a “Ready” key 230 for starting or commencing the current or desired operation; a “Copy” key 235 for setting a desired copying mode (e.g., one of single-single side, double-single side, single-double side, double-double side modes, and so forth); and a “Sort” key 240 for setting an electronic sorting mode.

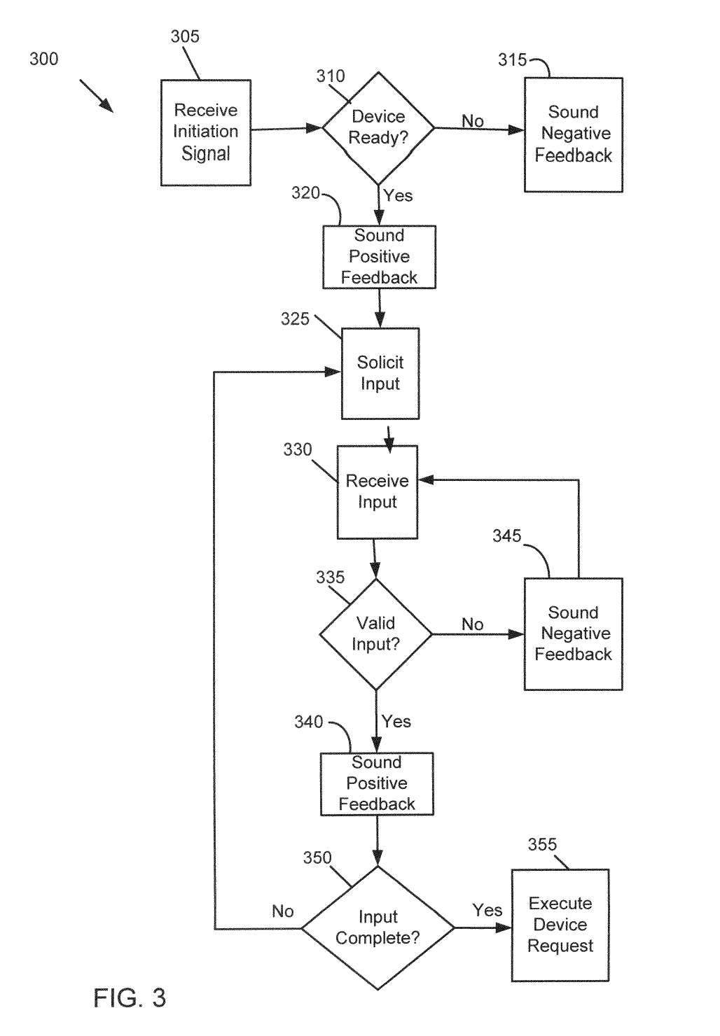

One exemplary process 300 for creating and executing a job using assistive technology, such as a combination of audio and visual feedback enhancements, is illustrated in FIG. 3. More particularly, process 300 helps a user in a “wizard-like” fashion to enter input through operation panel 150.

Process 300 treats received input as key-value pairs, associating the received input with the desired function to execute or attribute, parameter or instructions associated with the desired function. For example, if MFP device 100 is a combined photocopy/facsimile machine, following an audio prompt of “Press ‘1’ for ‘copy’” or “Press ‘2’ for ‘fax’”, receipt of a “1” from operational panel 150 can represent a function code for “copy,” while receipt of a “2” from operation panel 150 can represent a function code for a “fax.” In this example, an initiation input signal is received from a user (block 305) to return MFP device 100 to a pre-defined home state ready for input. The user can generate such signal by locating and activating or pressing any key or on the operation panel 150 of MFP device 100 or a preset or predetermined button or key, such as an idle or “Ready” key, to begin the job setup and execution process. The initiation input signal may also be numeric input entered at operation panel 150 using keypad 210 or a touchscreen display. In another example, the initiation input signal may be the picking up (i.e., off-hook signal) of a telephone headset connected to the operation panel 150 or the activation of an IVR system. In yet another example, the activation signal may be a signal generated from a portable auxiliary device being connected to MFP device 150, such as a flash memory device.

At block 310, MFP device 100 may verify whether MFP device 100 is ready to receive and perform requested functions. MFP device 100 may also provide the appropriate ready state feedback (blocks 315, 320) to the user, such as through an audio signal or visual display on operation panel 290. For example, if MFP device 100 is not in a ready state, it may provide negative feedback, such as. a “razz” sound, to indicate that a request cannot be honored, possibly due to, for example, MFP device 100 being in an intervention required state (e.g., out of paper or network down) and that further input is futile. If MFP device 100 is in a ready state, it may provide positive feedback, such as a “ding” sound, to indicate that requests can be honored and that MFP device 100 is ready to solicit user selections or input and perform desired functions.

At block 325, if MFP device 100 is in a ready state, MFP device 100 solicits input from the user. Soliciting may be presenting choices to a user through a display or touchscreen having the capability to display text and images in a size large enough for viewing correctly, such as through a wizard. Soliciting can also include audio sounds, visual indication, prompts or any combination thereof. Soliciting can further include one or more scripts of interactive audible requests. In one particular example, soliciting includes using a synthetic voice from an IVR system that prompts the user to enter input, such as reading a list of attributes, instructions, or parameters to the user.

The input received generates a request for MFP device 100 to perform a function, such as copying, faxing, scanning or e-mailing. The input received may also include a selection of one or more attributes, parameters or instructions. The input received may also be a previously stored job ticket, which may include a request to perform a function and one or more attributes, parameters or instructions associated with the function. For example, input may be one or more alphanumeric characters; a delimiter character; selections made by clicking on desired attributes, instructions or parameters with a mouse or other input device; or verbal responses recorded as a list of desired attributes, instructions or parameters are read to a user. Input can be received through key presses on a keyboard or touchscreen, mice, an IVR system or other input device, and the input devices may be assistive technology or specially designed for users with disabilities. For example, for visually-impaired users, the keyboard or touchscreen may have the capability to display text and images in a size large enough for viewing correctly or an IVR system which records a user's verbal responses as a list of attributes, instructions, or parameters are read to the user.

Once input from the user is received (block 330), MFP device 100 determines whether the input is valid at block 335. Validation includes verifying the input received is valid. For example, validation may help ensure that the function requested is recognized by MFP device 100 or that the attributes, parameters or instructions inputted can be associated with the selected function. Validation may further include checking to make sure that required parameters have been set.

Once validation at block 335 has been performed, feedback may be provided to the user (blocks 340, 345). Positive feedback, such as sounding a “ding” or voicing a success, indicates that progress is being made towards the successful creation of a job and may be signaled for valid inputs (block 340), and negative feedback, such as sounding a “razz” or voicing an error, may be signaled for invalid inputs (block 345). If the input received is invalid, MFP device 100 prompts the user to re-enter valid input. If the input received is valid, MFP device 100 continues soliciting additional functions, attributes, instructions or parameters. The solicitation, input, validation and feedback processes may be repeated until all desired attributes, instructions or parameters have been defined or an indication that the job creation or setup operation is complete, such as an end of input indicator or job creation indicator, a perform function signal, or a job submission indicator, is received (block 350). Once all job attributes, parameters, and instructions have been set, the job may also be known as a job program or job ticket. It will be appreciated by one of ordinary skill in the art that validation of the job may also occur after a predetermined number of inputs or after an end of input indication is received rather than after each individual input.

At block 355, the job is executed using valid received input.

Using the example of the photocopy/facsimile machine described above combined with an IVR system, a request for a copy may occur as follows. The user presses “Ready” key 230 on operation panel 150. Once MFP device 100 verifies that MFP device is in a ready state, it may provide positive feedback and then enable IVR system to prompt the user as follows: “Press ‘1’ for ‘Make a Copy’” or “Press ‘2’ for ‘Send a Fax.’” In an alternative embodiment, the IVR system is automatically enabled upon the verification that MFP device 100 is in a ready state.

After receiving the input of ‘1’ (in this example, through a user's voice response), the IVR system of operation panel 150 may produces an audible prompt, such as “Assisted copy mode—how many copies would you like to make?” Upon receiving the user's numeric voice response or input, MFP device 100 may verify the validity of the voice response and produce feedback, such as a “ding” sound to indicate a valid selection or a “razz” sound to indicate an invalid selection. If the input received is invalid, the key-value pair is ignored and may cause the verbal prompt of “How many copies would you like to make?” to be repeated. Additional verbal prompting is solicited until all desired attributes, parameters and instructions have been provided. Once all input is received, the creation of the job or job ticket is complete, and MFP device 100 processes such job or job ticket in the same manner that a user interacts with a standard MFP device.

One way method 300 can be practiced is device 100. In other embodiments, method 300 is resident in memory of a portable device, such as a flash memory device that can be connected to the MFP device 100, such as through a Universal Serial Bus (USB). In this example, plugging the portable device into the MFP device 100 initiates process 100 residing in the portable device.

Embodiments of the present invention can be implemented in digital electronic circuitry, or in computer hardware, firmware, software, or in combinations of thereof. Embodiments of the present invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

The exemplary of embodiments of the present invention can be performed by one or more programmable processors executing a computer program to perform functions of the present invention by operating on input data and generating output. The exemplary embodiments can also be performed by, and apparatus of the present invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

The foregoing description of several methods and an embodiment of the present invention have been presented for purposes of illustration. It is not intended to be exhaustive or to limit the invention to the precise steps and/or forms disclosed, and obviously many modifications and variations are possible in light of the above teaching. It is intended that the scope of the present invention be defined by the claims appended hereto.

What is claimed is:

1. A method for controlling a peripheral device comprising:
soliciting input from a user through assistive technology;
receiving input from the user in response to said soliciting; and
executing a job generated from said input.

2. The method of claim 1, wherein said soliciting input comprises prompting the user to enter input.

3. The method of claim 1, wherein the assistive technology is an interactive voice response system.

4. The method of claim 1, further comprising receiving an activation signal from the user.

5. The method of claim 4, wherein the activation signal is an off-hook headset signal.

6. The method of claim 4, wherein the activation signal is a signal from a connected portable auxiliary device.

7. The method of claim 6, wherein the auxiliary device is a Universal Serial Bus (USB) device.

8. The method of claim 1, wherein the input is one or more alphanumeric characters representing one or more desired functions, instructions, parameters or attributes.

9. The method of claim 1, wherein the input is a delimiter character.

10. The method of claim 1, further comprising determining whether the received input is valid.

11. The method of claim 10, further comprising:
providing a first indication for valid received input; and
providing a second indication for invalid received input.

12. The method of claim 1, wherein the job comprises a request to perform a function and one or more attributes, instructions or parameters.

13. A method for controlling a peripheral device equipped with assistive technology, comprising:
soliciting input from a user through a wizard;
determining whether the received input is valid;
receiving a completion indication from the user through a response to the wizard; and
executing a job in response to the received completion indication.

14. The method of claim 13, wherein the wizard is a script of interactive audible requests.

15. The method of claim 14, wherein the interactive audible requests are synthetic voice prompts.

16. The method of claim 13, wherein the input comprises one or more alphanumeric characters representing one or more peripheral device functions and associated attributes, instructions or parameters.

17. The method of claim 13, wherein said determining comprises verifying that received input represents valid peripheral device functions and associated attributes, instructions or parameters.

18. The method of claim 13, further comprising signaling in response to said determining.

19. The method of claim 18, wherein said signaling comprises:
a first indication signifying valid received input; and
a second indication signifying invalid received input.

20. The method of claim 13, wherein the completion indication is a special function key on the peripheral device.
